(19) United States
(12) Patent Application Publication
(10) Pub. No.: US 2004/0263852 A1
(43) Pub. Date: Dec. 30, 2004

(54) Aerial leak detector

(75) Inventors: Egor Degtiarev, Las Cruces, NM (US); Ralph Motto, Las Cruces, NM (US); Alexander Karpov, Las Cruces, NM (US)

Correspondence Address: PEACOCK MYERS AND ADAMS P C, P O BOX 26927, ALBUQUERQUE, NM, 871256927

(73) Assignee: LaSen, Inc., Las Cruces, NM

(21) Appl. No.: 10/861,817

(22) Filed: Jun. 3, 2004

Related U.S. Application Data
(60) Provisional application No. 60/475,382, filed on Jun. 3, 2003.
(60) Provisional application No. 60/475,380, filed on Jun. 3, 2003.

(51) Int. Cl. G01N 21/61

(52) U.S. Cl. 356/437

(57) ABSTRACT

A detector that can detect a gas which has leaked, particularly from buried and or exposed pipelines. The detector can be placed on an aircraft and flown at heights, e.g. up to about 500 feet, or other heights, and at relatively high speeds along the length of the pipeline. A tunable light source is programmed to switch between a first frequency, which is known to be absorbed by the gas in question, and a second frequency, which is known not to be as readily absorbed by the gas in question. A laser rangefinder is also provided to measure the distance between the pipeline and the detector. A computer is preferably provided to interpret readings from the sensors, based on distances measured by the laser rangefinder. A GPS receiver is also preferably provided.

### CROSS-REFERENCE TO RELATED APPLICATIONS

This application claims the benefit of the filing of U.S. Provisional Patent Application Ser. No. 60/475,382, entitled “Airborne Laser Based System for Inspection of Natural Gas and Hazardous Liquid Transmission Pipelines”, filed on Jun. 3, 2003; as well as U.S. Provisional Patent Application Ser. No. 60/475,380, entitled “Fast Optical Wavelength Shifter”, filed on Jun. 3, 2003 and the specifications thereof are incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. F33615-98-C-1203 awarded by the U.S. Air Force.

### BACKGROUND OF THE INVENTION

1. Field of the Invention (Technical Field)

The present invention relates to a method and apparatus for airborne laser-based detection of leaks. Particularly, the present invention relates to a method and apparatus for detection of gaseous hydrocarbons which have leaked from buried and non-buried pipelines.

2. Description of Related Art

Note that the following discussion refers to a publication that due to recent publication date is possibly not to be considered as prior art vis-a-vis the present invention. Discussion of such publication herein is given for more complete background and is not to be construed as an admission that such publication is prior art for patentability determination purposes.

There is no such thing as a pipeline which can last forever and never leak. Thus, leaks can be expected to occur. Leaks not only result in wasted product and thus increased operating costs, but leaks can also cause environmental and health problems. If flammable gas leaks from a pipeline, a massive explosion can easily be triggered by even the smallest of sparks.

Although gas detectors have been known for some time, most require that the detector be carried along and very near to the pipeline. Therefore, gas detectors must typically be carried along the ground. Since pipelines often stretch for miles and cross the properties of numerous individual landowners, carrying a detector across the ground is often a difficult and arduous process, requiring a user to climb several fences and or obtain numerous gate keys. Pipelines also often lie in areas which are difficult to access and negotiate due to hills, valleys, creeks, trees and underbrush. Thus, an aerial gas detector permits a user to not only inspect a pipeline without subjecting a user to the navigation of arduous environmental terrains, but also enables rapid inspection of large areas. As yet another advantage, a ground survey of a pipeline typically achieves survey distances on the order of around 10 miles per day. The present invention, in contrast, can achieve survey rates of greater than 20 miles per hour.

U.S. Pat. No. 5,742,053 to Rekunyk, entitled “Infrared Gas Detection Method and Apparatus”, discloses the use of an aircraft for detecting gas leaks from a pipeline. The Rekunyk invention, however, requires the aircraft to travel about 50 feet off the ground at speeds of between 50 and 100 miles an hour. Even when pipeline right-of-ways have been cleared of trees, electric utility lines continue to cross the right-of-way. An aircraft traveling at up to 100 miles per hour which is only 50 feet above the ground is a very dangerous thing. The Rekunyk invention must travel close to the ground because the leak detector disclosed therein requires the gas to pass between an Infrared (IR) emitter and an IR receiver. Since the emitter and receiver must lie directly across from one another, they must be securely fixed to the aircraft and the aircraft itself must pass through the gas plume created by the leak.

Aerial leak detection has also been achieved through the aid of backscatter laser imaging. This technology is quite complex and expensive. A visual graphic two-dimensional image of the gas plume is created on a display. Further, the creation of a two-dimensional image takes significantly longer, thus significantly slowing down the survey speed.

At a conference held on Sep. 17 and 18, 2001, and later published in Proceedings of the Society for Optical Engineering, on pages 74-81, in volume 4546, published in 2002, a differential laser gas leak detector was disclosed by LaSen, Inc. (Applicant). As described therein, a gas, for example methane, could be detected remotely by using a differential laser capable of quickly switching between two frequencies. It was disclosed that one frequency should be chosen which corresponds with a frequency known to be absorbed by the gas in question, and that the other frequency should be chosen which the gas in question is known not to absorb as readily. However, such leak detector was not viable for operation from an airborne platform. First, when the leak detector is operated from such a platform, the distance between the leak detector and the area on the ground illuminated by the laser will be subject to constant and unavoidable changes due to motion of the aircraft. Because methane is normally present in the atmosphere at the average concentration of 1.7 parts-per-million, these distance changes would result in the uncertainty in the determination of whether the methane concentration at a particular location exceeds a normal background level, such excess concentration being indicative of a potential gas leak. Thus, the system must incorporate a way to accurately and continuously measure the distance between the detector and the target area on the ground. Additionally, using the leak detector on a mobile platform necessitates the need to continuously log the positional information in order to monitor the surveyed area as well as to pinpoint the location of detected leaks.

Accordingly, the present invention was developed to address these problems, thus providing a gas leak detector which can be efficiently operated from an aircraft.

### BRIEF SUMMARY OF THE INVENTION

The preferred embodiment of the present invention is directed toward an apparatus and method for detecting a gas leak. The invention comprises one or more light sources for producing a plurality of different electromagnetic frequencies, a return energy detector, a rangefinder, and at least one computer. The computer is capable of modifying readings obtained from the return energy detector based on a distance from the rangefinder to a point of reflection. The distance is obtained from the rangefinder.

The light sources preferably comprise an optical parametric oscillator, or one or more lasers. The light source can be a tunable light source. The rangefinder is preferably a laser rangefinder.

The invention also preferably has a Global Positioning System receiver, a digital camera, and one or more gas sample holders. The gas sample holders preferably have a secondary energy sensor attached to them. The apparatus preferably also has one or more beam splitters.

The computer obtains a value from the Global Positioning System receiver. The computer continuously logs the position of the leak detecting apparatus. A computer also stores a spatial location upon detection of the gas leak.

The readings are calibrated based on calibration readings obtained from the secondary energy sensor attached to the gas sample holder.

A plurality of light pulses are directed toward a pipeline location. The light pulses comprise at least two different frequencies. Reflections of these pulses are observed by a return energy sensor. The computer compares the absorption spectrum obtained at different electromagnetic frequencies by the return energy sensor. The computer then calculates a gas concentration value. This concentration value can be modified by the computer based on a measured distance.

The invention may further comprise alternating between a frequency known to be absorbed by a target gas and a frequency known not to be as readily absorbed by a target gas.

The plurality of light pulses can be directed toward a pipeline from an aircraft. The pipeline may be inaccessible to the light pulses. If this is the case, the pipeline location can be the ground or other structure above or very near the inaccessible pipeline.

A primary object of the present invention is to provide a method and apparatus for detecting a gas leak from an aerial platform. An advantage of the present invention is that a pipeline can be monitored by an aircraft while traveling at a safe height above the ground. A further advantage of the present invention is that pipelines which are difficult to access on the ground can be rapidly tested from the air.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a simplified diagram illustrating the basic concepts of the present invention; and

FIG. 2 is a depiction of a preferred embodiment of the apparatus of the present invention.

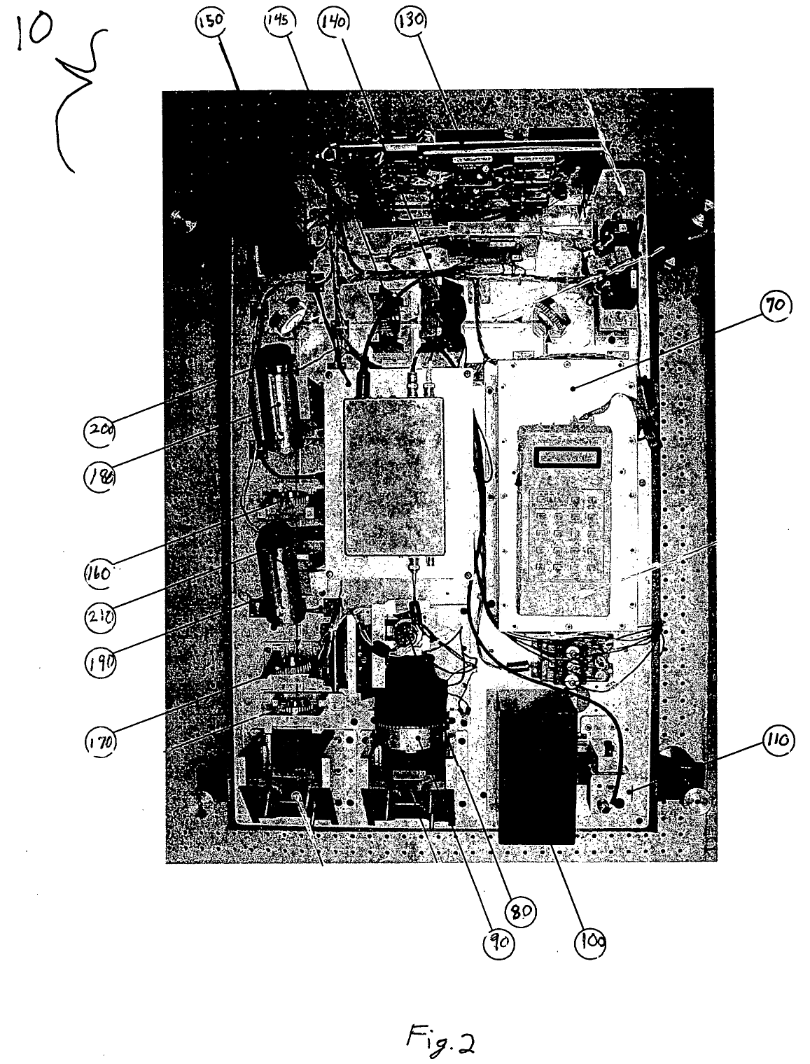

### DETAILED DESCRIPTION OF THE INVENTION

The present invention is directed to a method and apparatus for use in the detection of leaks from pipelines, as well as for determining spatial locations thereof. More particularly, the present invention is directed toward an improved method and apparatus for detecting gas leaks from pipelines, which are buried or exposed, by employing an aircraft which can travel at relatively high speeds and need not fly dangerously close to the ground.

The term “gas” as used throughout the specification and claims is intended to be given its ordinary meaning and to include compressed gases as well as liquids, which create gas vapors or convert directly into a gas upon escaping from the pipeline. While the present invention can be used to detect any type of gas, propane, butane, natural gas, methane, and ethane are the gases which the present invention is preferably used to detect.

As used throughout the specification and claims, the terms “light source” and “light” mean any coherent or incoherent light source, including but not limited to lasers, optical parametric oscillators, and the like, and light therefrom. Further, the terms “light source” and “light” as used throughout the specification and claims are not intended to be limited to only visible light. Rather, the term “light source” is meant to include all frequencies of the electromagnetic spectrum.

Further, the term “pipeline” as used throughout the specification and claims is used for the sake of maintaining simplicity and is intended to include any and all devices, apparatuses, and structures capable not only of transporting material, but also those devices, apparatuses and structures which can be used to store and/or contain material including, but not limited to above ground and below ground storage tanks. For the purposes of the present invention, a “pipeline” may be aboveground and either visible from the air or having an unobstructed view from the air, below ground, or otherwise enclosed in a structure.

The term “computer” as used throughout the specification and claims is used for the sake of simplicity and is intended to include any and all electronic devices capable of taking readings from sensors and performing actions based upon those readings. As such, the term “computer” includes but is not limited to computers, processors, microcontrollers, microprocessors, and electronic circuitry capable of performing the above described functions, as well as multiples and combinations of these.

While virtually any type of rangefinder can be used and will provide desirable results, the rangefinder of the present invention is preferably a “laser rangefinder”. The term “rangefinder”, as used throughout the specification and claims, is intended to include any type of rangefinder as well as other apparatuses for measuring distance.

Due to the large array of flying vehicles and structures, the term “aircraft” as used throughout the specification and claims is intended to include all devices, apparatuses, and structures which can travel through the air, including but not limited to airplanes, and helicopters, as well as unmanned aircraft which also include but are not limited to radio controlled airplanes and helicopters.

While the preferred embodiment of the present invention includes an optical parametric oscillator for switching between two different frequencies, desirable results can also be obtained by providing two different fixed frequency light sources, one set at a frequency known to be absorbed by the target gas, and the other set at a frequency known not to be as readily absorbed by the target gas.

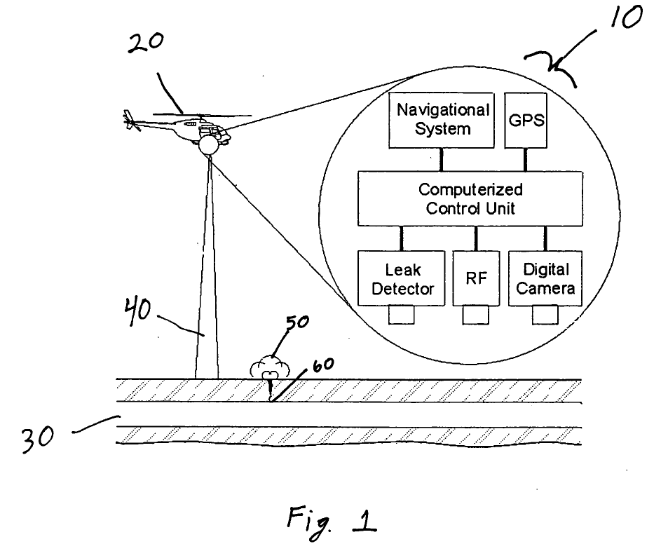

FIG. 1 shows a simplified diagram illustrating the basic concepts of the present invention. As depicted therein, gas leak detector 10 is disposed on aircraft 20. As aircraft 20 flies above pipeline 30, beam 40 is directed to an area directly above pipeline 30. Gas 50 escaping from leak 60 is detected by leak detector 10. Although beam 40 is depicted as diverging, beam 40 may or may not diverge depending on which type of light source and beam shaping optics is used.

Referring to the figures, the gas leak detecting apparatus of the present invention is generally depicted as element 10. Leak detector 10 preferably has tunable light source 70 which is capable of rapidly switching between at least two frequencies. Return energy sensor 80 may be any of a number of energy sensors available which can produce desirable results, including but not limited to a Judson Technologies Brand J10D InSb cryo-cooled energy detector. Energy sensor 80 is capable of detecting light from light source 70 which is reflected back from the Earth, pipeline, or other structure which resides substantially below aircraft 20. Leak detector 10 is also equipped with light collecting optics 90, and rangefinder 100, preferably a laser rangefinder. Digital camera 110 as well as Global Positioning System (GPS) receiver 120, are also preferably connected to detector 10.

While those skilled in the art will readily recognize that the present invention can be equipped to be powered from batteries or other power sources which can supply the required current and voltage to each of the components of the present invention, detector 10 preferably has power supply 130 having several voltage converters and regulators, which provides electricity to each element of the apparatus at their appropriate voltage and current levels. Power to supply 130 is preferably a direct current source such as a battery.

Pyro-electric energy detector 140 is preferably provided to measure the intensity of each pulse of beam 40. A portion of the beam 40 from light source 70 is preferably reflected back to secondary energy sensor 140 with the aid of beam splitter 145. This intensity measurement is used by computer 150 to compensate for any fluctuations in the shot to shot intensity of light source 70. A decrease in intensity of an on-line pulse, which is discussed below, can result in a false detection of gas leak 60. Constant knowledge of the actual output intensity of every shot of light source 70 thus enables accurate and consistent measurements of gas 50 which has escaped through leak 60.

While not essential components of the present invention, detector 10 preferably includes beam splitters 160 and 170 which reflect a portion of beam 40 through sample holders 180 and 190 and onto secondary energy sensors 200 and 210. Since natural gas pipelines will likely be the most commonly inspected pipeline, and because methane and ethane constitute the vast majority of the makeup of natural gas, it is preferable that a sample of ethane gas be disposed in sample holder 190, and that a sample of methane gas be disposed in sample holder 180. The ability to pass beam 40 through known quantities of the target gas, enables the present invention to be able to quickly and easily be calibrated by placing computer 150 into a calibration mode and then reading the output of secondary sensors 200 and/or 210.

Computer 150 is preferably used to compile data received from each of the energy sensors, as well as laser rangefinder 100, GPS receiver 120, and digital camera 110. Additionally, computer 150 controls light source 70 through an electrical connection therebetween. Computer 150 not only turns light source 70 on and off, but computer 150 can also set the light source 70 to switch between the specific on-line and off-line frequencies.

Having explained the elements of the apparatus of the present invention, the operation is now described. A user first selects a pipeline to survey. Next, the user determines the type of gas 50 that will be emitted if pipeline 30 has leak 60. The user then sets light source 70 to switch between a first optical frequency, which is coincident with the peak of an absorption line of the target gas, and a second optical frequency that is detuned from the peak of the same absorption line of the target gas (the gas tested for), this method is also known as differential absorption. These two frequencies are hereinafter referred to as the “on-line” and “off-line” frequencies respectively. As an example, the wavelengths of the frequencies which are preferably used to detect methane are 3.392 μm for the on-line frequency, and 3.387 μm for the off-line frequency. The 3.392 μm wavelength equates to the P(7) absorption line for methane gas. Both the “on-line” and “off-line” frequencies are chosen in such a way as to minimize their absorption by normal atmospheric constituents such as water. After these frequencies have been programmed into light source 70, detector 10 is flown substantially directly above pipeline 30. The height at which detector 10 is flown above pipeline 30 is preferably one which enables beam 40, emitted from light source 70, to illuminate an area of about 20 to about 30 feet in diameter on the ground.

Once the aircraft has obtained approximately the appropriate distance above the ground, detector 10 is switched on. Computer 150 first causes light source 70 to emit an off-line pulse. The pulses referred to herein can be reflected from the pipeline, however, if the pipeline is buried or otherwise inaccessible, the pulse can be reflected from the ground or other structure immediately adjacent the pipeline. Further, in the case of a buried pipeline, beam 40 is preferably reflected from the ground directly above pipeline 30. The ground reflection of this off-line pulse is detected by return energy sensor 80 and recorded by computer 150. This off-line pulse is used by computer 150 to determine a baseline estimate of what the magnitude of the on-line pulse should be when gas 50 is not present and does not absorb the subsequent on-line pulse. Immediately following the reading and recording of the off-line pulse, as measured by return energy sensor 80, computer 150 causes light source 70 to emit an on-line pulse. Less than 10 milliseconds (ms) is the preferred time between an off-line pulse and a subsequent on-line pulse, although this may be adjusted to account for different speeds of the aircraft. Computer 150 records the return pulse reading from return energy sensor 80 and compares this reading with that of the previous off-line pulse. This ensures the area of reflection which the subsequent on-line pulse is reflected from is essentially the same area of reflection from which the off-line pulse was reflected. If the amplitude of intensity of the on-line pulse has been diminished more than anticipated, computer 150 stores indicia that a leak has occurred. While the present invention can produce desirable results with fewer pulses, light source 70 produces a pulse rate which is preferably from 5 to 500 pulses per second. This pulse rate represents the number of subsequent on-line pulses, since an on-line pulse preferably immediately follows the off-line pulse, the total number of pulses per second is twice this range. In order to accurately locate leak 60, an overlap of subsequent ground illuminations of greater than 90% is preferable.

While the present invention can be used to detect virtually any gas, it is anticipated that users will likely program detector 10 to search for methane gas when testing the integrity of a natural gas pipeline. This is because methane typically constitutes more than 87% of a volume of natural gas, which means that it will be much more readily detected. One problem with checking for methane is that it is produced naturally, and is normally present in the atmosphere. As such, one would expect that the greater the distance which beam 40 must travel will naturally result in a greater on-line absorption for methane gas. Thus, as the height of aircraft 20 increases, computer 150 will detect more methane gas. This increase may be misinterpreted as the indication of the presence of a leak. To compensate for such distance changes, data from laser rangefinder 100 is provided to computer 150 which in turn uses the data from rangefinder 100 to compensate for the increase in path-integrated methane levels as the distance between aircraft 20 and the ground increases. A homogenous mixture of methane gas in the atmosphere is assumed, thus, computer 150 normalizes the path-integrated concentration of methane measured by detector 10 to the distance between detector 10 and the target area on the ground measured by rangefinder 100. If this normalized concentration exceeds a certain threshold taken as the local background level, computer 150 classifies the present location as a potential leak site. Providing rangefinder 100 enables a user to forego the impossible task of continuously navigating aircraft 20 such that a distance between return energy sensor 80 and the target area remains constant. The present invention can produce desirable results at up to about 500 feet above the ground. Even greater operating distances are obtainable with the present invention. However, the accuracy of readings decreases as height increases above 500 feet. While numerous hills, trees, radio towers, highlines, and water towers must be dodged by a pilot flying at less than 150 feet above the ground, very few of these extend to distances of 500 feet above the ground. Thus, the present invention enables a user to inspect a pipeline with far greater safety and accuracy while avoiding far fewer obstacles.

Because methane is produced from a wide array of natural sources, determining that gas leak 60 has occurred simply because of a sudden increase in methane levels can result in several “false positives”. For example, if a cow were to die next to a pipeline, the decaying carcass may generate sufficient levels of methane to trigger a false reading in the apparatus of the present invention. Therefore, when testing for methane which has leaked from a natural gas pipeline, it is recommended that upon detecting a leak, detector 10 should be then be set to detect for ethane, for example, 3385 nm (on-line) and 3381 nm (off-line). Light source 70 and computer 150 can be manually switched to check for the presence of ethane, or computer 150 can be programmed to automatically test for the presence of ethane after methane is discovered. Since manual reprogramming detector 10 to look for ethane takes a considerably longer period of time, the user should cause aircraft 20 to return to the place where the methane was detected. If ethane is also detected, then an actual leak will be known to exist.

The greater the amount of gas 50 through which beam 40 must pass results in increased absorption of the on-line pulse. Thus, computer 150 can quantify the amount of gas through which laser beam 40 is passing. Due to wind and other environmental conditions, this measured amount is not necessarily directly equivalent to the amount or rate of gas 50 which is escaping from leak 60.

A Global Positioning System (GPS) receiver 120 is preferably connected to computer 150. Computer 150 preferably logs a continuous stream of GPS coordinates. Thus, at the end of an inspection, the data can be reviewed to see exactly what portions of pipeline 30 were inspected, and if a leak was detected, the pinpoint location of where the leak was detected. GPS receiver 120 can also be used to assist in navigating aircraft 20 such that it flies directly above pipeline 30.

A digital camera is also preferably provided. Digital images taken by digital camera 110 are preferably sent to computer 150. These images can be used for identifying the location and/or physical signs of leak 60, damage to pipeline 30, as well as third party encroachments. The digital images can also be used for monitoring construction activity in the proximity of pipeline 30 for the purposes of classifying location in accordance with Title 49 CFR, Part 192.

While the preferred embodiment of the present invention has computer 150, a transmitter can easily be provided such that all data from the various sensors is transmitted to computer 150 which is external to other components of detector 10. For example, if a remote flying aircraft is used, a computer local to the operator can receive the transmitted signals. Providing computer 150 external to detector device 10 can thus aid in weight reduction.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An apparatus for detecting a gas leak, the apparatus comprising:
one or more light sources for producing a plurality of different electromagnetic frequencies;
a return energy detector;
a rangefinder; and
at least one computer, said computer capable of modifying readings obtained from said return energy detector based on a distance from said rangefinder to a point of reflection, the distance obtained from said rangefinder.

2. The gas leak detector of claim 1 wherein said one or more light sources comprise an optical parametric oscillator.

3. The gas leak detector of claim 1 wherein said one or more light sources comprise one or more lasers.

4. The gas leak detector of claim 1 further comprising a Global Positioning System receiver.

5. The gas leak detector of claim 4 wherein said computer obtains a value from said Global Positioning System receiver.

6. The gas leak detector of claim 5 wherein said computer continuously logs the position of said leak detecting apparatus.

7. The gas leak detector of claim 5 wherein one of said at least one computer stores a spatial location upon detection of the gas leak.

8. The gas leak detector of claim 1 further comprising a digital camera.

9. The gas leak detector of claim 1 wherein said rangefinder comprises a laser rangefinder.

10. The gas leak detector of claim 1 further comprising one or more gas sample holders.

11. The gas leak detector of claim 1 wherein said one or more gas sample holders each comprise a secondary energy sensor attached thereto.

12. The gas leak detector of claim 11 further comprising one or more beam splitters.

13. The gas leak detector of claim 12 wherein said readings are calibrated based on calibration readings obtained from said secondary energy sensor attached to said gas sample holder.

14. The gas leak detector of claim 1 wherein said computer compares absorption values obtained at different electromagnetic frequencies by said return energy sensor.

15. A method of detecting for a gas leak from a pipeline, the method comprising the steps of:
directing a plurality of light pulses toward a pipeline location, the light pulses comprising at least two different frequencies;
obtaining readings from a return energy sensor and measuring reflections of the pulses;
comparing absorption values of the reflections obtained at the at least two different frequencies;
calculating a concentration value;
obtaining a distance between the return energy sensor and the pipeline location; and
adjusting the concentration value based on the distance obtained.

16. The method of claim 15 wherein the step of directing a plurality of light pulses comprises the step of alternating between a frequency known to be absorbed by a target gas and a frequency known not to be as readily absorbed by a target gas.

17. The method of claim 15 wherein the step of directing a plurality of light pulses comprises the step of directing a plurality of light pulses toward a pipeline from an aircraft.

18. The method of claim 15 wherein the pipeline is inaccessible to the light pulses.

19. The method of claim 18 wherein the pipeline location comprises ground above the inaccessible pipeline.

20. The method of claim 15 wherein the step of obtaining readings comprises the step of obtaining readings with a computer.

21. The method of claim 15 wherein the step of comparing absorption values comprises comparing absorption values with a computer.

22. The method of claim 15 wherein the step of obtaining a distance comprises obtaining a distance with a rangefinder.

23. The method of claim 22 wherein the step of obtaining a distance comprises obtaining a distance with a laser rangefinder.

24. The method of claim 15 wherein the step of adjusting the absorption value comprises adjusting the absorption value with a computer.

25. The method of claim 15 further comprising the step of calculating a baseline atmospheric value based on a natural concentration of the gas and the distance.

26. The method of claim 15 wherein the directing step is performed with a single light source.

27. The method of claim 26 wherein the light source is tunable.

28. The method of claim 15 wherein the directing step is performed with a plurality of light sources.

29. The method of claim 26 wherein the directing step is performed with an optical parametric oscillator.

30. The method of claim 15 further comprising the step of determining a spatial location of the leak detector.

31. The method of claim 30 wherein the step of determining a spatial location comprises determining a spatial location with a Global Positioning System receiver.

32. The method of claim 30 further comprising the step of logging a plurality of spatial locations of the leak detector.
